(19) United States
(12) Patent Application Publication
(10) Pub. No.: US 2024/0144206 A1
(43) Pub. Date: May 2, 2024

(54) Payment System and Method for Improving Security Pricing Using Digital Tokens in a Closed Loop

(71) Applicant: FairShares, Inc., Delray Beach, FL (US)

(72) Inventors: David Boydell, Sonoma, CA (US); Jeremy Roseberry, Delray Beach, FL (US)

(73) Assignee: FairShares, Inc., Delray Beach, FL (US)

(21) Appl. No.: 18/273,412

(22) PCT Filed: Feb. 17, 2022
(86) PCT No.: PCT/US22/16759

§ 371 Date: Jul. 20, 2023

Related U.S. Application Data
(60) Provisional application No. 63/150,388, filed on Feb. 17, 2021.

(51) Int. Cl. G06Q 20/08; G06Q 20/06; G06Q 40/02

(52) U.S. Cl. CPC G06Q 20/0855; G06Q 20/065; G06Q 40/02

(57) ABSTRACT

A system includes: a closed loop comprising a member; a server operably connected to the closed loop, the server configured to process ownership data regarding ownership of a security by the member; a distribution administrator operably connected to the server, the distribution administrator configured to create a digital token to track ownership of the security by the member, thereby generating updated ownership data; and a security holder configured to hold the security, the security holder further configured to receive a total distribution on behalf of a member of the closed loop, the security holder further configured to send the total distribution to the distribution administrator, wherein the server is further configured to compute, using the updated ownership data, a distribution amount to be paid to a member of the closed loop, wherein the distribution administrator is configured, using the distribution amount, to pay the member the distribution amount.

### PRIORITY CLAIM

The present application claims the priority benefit of U.S. provisional patent application No. 63/150,388 filed Feb. 17, 2021 and entitled “Method and System for Improving Security Pricing and for Managing Security Orders Using a Closed Loop System,” the disclosure of which is incorporated herein by reference.

### SUMMARY

Embodiments of this invention provide a payment system and method for improving security pricing using digital tokens in a closed loop.

A payment system and method for improving security pricing using digital tokens in a closed loop includes: a security holder; a distribution administrator operably connected to the security holder, the distribution administrator configured to track ownership of a security within the closed loop during a given payment period using a digital token, the security holder configured to transmit to the investor, via the distribution administrator, a distribution of income generated by a security during a payment period; a custodian operably connected to the server; a broker operably connected to the custodian, the broker configured to receive the distribution of income from the custodian; and a member, the investor operably connected to the broker, wherein the broker is further configured to equitably distribute to the investor income from a given security in a given payment period in proportion to a number of ownership credits of the digital token owned by the investor during the payment period.

A payment system for improving security pricing using digital tokens in a closed loop includes: a closed loop comprising a member; a server operably connected to the closed loop, the server configured to do one or more of control the system and process ownership data regarding ownership of a security by the member; a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount.

A payment system for improving security pricing using digital tokens in a closed loop includes: a closed loop comprising a member; a server operably connected to the closed loop, the server configured to do one or more of control the system and process ownership data regarding ownership of a security by the member, wherein the server computes all distribution amounts due to all members of the closed loop, wherein the server sends the computed distribution amount to the member; a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server, wherein the server sends the computed distribution amount to the distribution administrator, wherein the distribution administrator sends the updated ownership data to the system database; a security holder operably connected to the distribution administrator, the security holder configured to hold the security, the security holder further configured to receive a total distribution on behalf of a member of the closed loop, the security holder further configured to send the total distribution to the distribution administrator; and storage operably connected to the server, the storage configured to store one or more of ownership data and a computed distribution amount, wherein the server sends the computed distribution amount to the storage, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, wherein the digital token comprises an electronic data unit configured to provide a member of the closed loop with an ownership credit that represents a legal right to income generated by the underlying security that the digital token represents, wherein the digital token represents one share of the security owned by a member during a payment period of the security, wherein the member comprises one or more of an investor and an intermediary appointed by the investor to act on the investor's behalf, wherein the intermediary ultimately pays the payment to the investor, wherein the intermediary is operably connected to the investor, wherein the intermediary is operably connected to the distribution administrator, wherein the intermediary comprises one or more of a broker, a custodian, and a bank, wherein the intermediary is configured to do one or more of hold the digital token on behalf of the investor, hold cash on behalf of the investor, hold another asset on behalf of the investor, consummate a transaction on behalf of the investor, receive a distribution on behalf of the investor, pay a distribution to the investor, and perform an administrative task on behalf of the investor, wherein the distribution administrator computes the distribution amount to be paid to the member using an equation:

$$Distribution Amount = ( \frac{TD}{TOC} ) * Ownership Credits , \qquad ( 2 )$$

where TD=equals a total distribution for a security that is held by the security holder, where TOC=a total number of ownership credits that were generated by the digital token in the payment period, and where Ownership Credits represents a number of ownership credits earned in the payment period by the member of the closed loop.

A method for improving security pricing using digital tokens in a closed loop includes: using a system comprising a closed loop comprising a member, a server operably connected to the closed loop, the server configured to do one or more of control the system and process ownership data regarding ownership of a security by the member, a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder operably connected to the distribution administrator, the security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, receiving, from the member, the ownership data; creating a digital token to track ownership of the security by the member during the payment period; tracking ownership of the security by the member during the payment period, generating updated ownership data; receiving a total distribution on behalf of the member; computing, using the updated ownership data, a distribution amount to be paid to the member; and using the distribution amount, paying the member the distribution amount.

A method for improving security pricing using digital tokens in a closed loop includes: using a system comprising a closed loop comprising a member, a server operably connected to the closed loop, the server configured to do one or more of control the system and process ownership data regarding ownership of a security by the member, a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder operably connected to the distribution administrator, the security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, receiving, from the member, the ownership data; creating a digital token to track ownership of the security by the members during the payment period; tracking ownership of the security by the member during the payment period, generating updated ownership data; receiving a total distribution on behalf of the members; calculating an ownership credit earned by each member of the closed loop based on each digital token owned by the respective member for the unit of time; computing, using the updated ownership data, all distribution amounts due to all members of the closed loop, wherein the computing step further comprises computing the distribution amount to be paid to the member using an equation:

$$Distribution Amount = ( \frac{TD}{TOC} ) * Ownership Credits , \qquad ( 2 )$$

where TD=equals a total distribution for a security that is held by the security holder, where TOC=a total number of ownership credits that were generated by the digital token in the payment period, and where Ownership Credits represents a number of ownership credits earned in the payment period by the member of the closed loop; sending the computed distribution amounts to all the members; and using the distribution amount, paying the members the distribution amounts.

A payment system for improving security pricing using digital tokens in a closed loop includes: a closed loop comprising a member; a server operably connected to the closed loop, the server configured to do one or more of control the system and process ownership data regarding ownership of a security by the member, wherein the server computes all distribution amounts due to all members of the closed loop, wherein the server sends the computed distribution amount to the member; a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server, wherein the server sends the computed distribution amount to the distribution administrator, wherein the distribution administrator sends the updated ownership data to the system database; a security holder operably connected to the distribution administrator, the security holder configured to hold the security, the security holder further configured to receive a total distribution on behalf of a member of the closed loop, the security holder further configured to send the total distribution to the distribution administrator; and storage operably connected to the server, the storage configured to store one or more of ownership data and a computed distribution amount, wherein the server sends the computed distribution amount to the storage, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, wherein the digital token comprises an electronic data unit configured to provide a member of the closed loop with an ownership credit that represents a legal right to income generated by the underlying security that the digital token represents, wherein the digital token represents one share of the security owned by a member during a payment period of the security, wherein the member comprises one or more of an investor and an intermediary appointed by the investor to act on the investor's behalf, wherein the intermediary ultimately pays the payment to the investor, wherein the intermediary is operably connected to the investor, wherein the intermediary is operably connected to the distribution administrator, wherein the intermediary comprises one or more of a broker, a custodian, and a bank, wherein the intermediary is configured to do one or more of hold the digital token on behalf of the investor, hold cash on behalf of the investor, hold another asset on behalf of the investor, consummate a transaction on behalf of the investor, receive a distribution on behalf of the investor, pay a distribution to the investor, and perform an administrative task on behalf of the investor, wherein the distribution administrator computes the distribution amount to be paid to the member using an equation:

$$Distribution Amount = ( \frac{TD}{TOC} ) * Ownership Credits , \qquad ( 2 )$$

where TD=equals a total distribution for a security that is held by the security holder, where TOC=a total number of ownership credits that were generated by the digital token in the payment period, and where Ownership Credits represents a number of ownership credits earned in the payment period by the member of the closed loop.

### BRIEF DESCRIPTION OF THE FIGURES

The figures depict various embodiments for purposes of illustration only. One skilled in the art will readily recognize from the following discussion that alternative embodiments of the structure and methods illustrated herein may be employed without departing from the principles described herein.

FIG. 1 illustrates an exemplary payment system for improving security pricing using digital tokens in a closed loop.

FIG. 2 illustrates a hierarchical representation of an exemplary payment system for improving security pricing using digital tokens in a closed loop.

FIG. 3 is a graph of pricing of a security according to the prior art system and using the payment system for improving security pricing using digital tokens in a closed loop.

FIG. 4 is a flow chart of a method for improving security pricing using digital tokens in a closed loop.

FIG. 5 is a flow chart of a method for improving security pricing using digital tokens in a closed loop.

### DETAILED DESCRIPTION

While the present invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the following description and in the several figures of the drawings, like reference numerals are used to describe the same, similar or corresponding parts in the several views of the drawings.

Embodiments of the invention provide a method and system for improving security pricing in a closed loop using a digital token. For the purpose of this application, a closed loop is defined as any system comprising one or more members whose ownership of a digital token is trackable by the system. The digital token comprises an electronic data unit that provides a member of the closed loop with an ownership credit that represents a legal right to income generated by the underlying security that the digital token represents. The digital token represents one share of a security owned by a member during a payment period of the security. For the purpose of this application, a share is equal to one ownership unit of a security. For example a share is equivalent to one share of Apple, Inc. For example, one share is equivalent to 1 bond or fixed income security. The digital token will remain active until it is redeemed for the physical security or until the physical security is transferred out of the closed loop. The system is also configured to create digital tokens that will expire on a certain date in the future.

The system comprises a security holder configured to hold the security. The security holder is further configured to receive a total distribution on behalf of a member of the closed loop. The system further comprises a distribution administrator configured to receive ownership data regarding ownership of a security from the member. The ownership data comprises one or more of ownership of a digital token by a member of the closed loop and a location of the digital token owned by the member. The distribution administrator is further configured to track ownership of a security within the closed loop system during a given payment period.

The security holder is further configured to send the total distribution to the distribution administrator. A member comprises one or more of an investor and an intermediary appointed by the investor to act on the investor's behalf. Ownership of a digital token is equivalent to ownership by the member of the underlying security held by the security holder. The total distribution comprises all distributions due to members of the closed loop for a security owned by the members within the closed loop during the current payment period. The distribution administrator is configured to accept a new member into the closed loop.

According to further embodiments of the invention, the distribution administrator can appoint a security holder to do one or more of hold the securities and receive a total distribution on behalf of the members of the closed loop. According to still other embodiments of the invention, the distribution administrator can appoint a security holder to both hold the securities and receive the total distribution on behalf of the members of the closed loop. The security holder, as a last holder of record of the security, is paid a total distribution due to all security holders in the closed loop.

The distribution administrator can deliver cash or another income payment to all members and members within the closed loop. Alternatively, the distribution administrator can provide payment instructions to each member so that each member can make its own distribution.

The distribution administrator is configured to create a digital token to track ownership of a security by a member within the closed loop during a payment period. The distribution administrator is further configured to create digital tokens to track ownership of all the securities owned by the members during the payment period. The distribution administrator credits the digital token to an account of the member who contributes the security associated with the digital token to the security holder.

A digital token represents an ownership right to a share of the underlying security held by the security holder. Preferably, but not necessarily, each digital token represents an ownership right to the share of the underlying security. The system computes an ownership credit earned by a member based on a digital token owned by the member of the closed loop for a unit of time. An ownership credit represents a right to the member's pro rata portion of the income distributed for a payment period by the underlying security that the digital token represents. Preferably, but not necessarily, the system computes an ownership credit earned by the member based on all digital tokens owned by the member for the unit of time. Most preferably, but not necessarily, the system computes an ownership credit earned by each member of the closed loop based on each digital token owned by the respective member for a unit of time. The system designates the unit of time. For example, the unit of time comprises one or more of an hour, a day, a week, a month, a quarter, and a year. Preferably, but not necessarily, the unit of time comprises a day. For example, if a member owns one digital token for five days, and the unit of time designated by the system is one day, then the member earns five ownership credits. The system is configured to process all types of distributions in proportion to the ownership credits generated in each payment period for each distribution type.

For example, a digital token represents one Apple, Inc. share owned by the member during the payment period. The system derives a price of the digital token from the price of the underlying security that the digital token represents. Typically, but not necessarily, the system derives a fixed price for the digital token. Alternatively, or additionally, the price of the digital token is not fixed and the members transact in the underlying security at an agreed price.

For example, after the distribution administrator creates a digital token of Apple, Inc., using the digital token, the distribution administrator tracks the price of Apple, Inc. stock. The distribution administrator tracks ownership of the digital token by the member of the closed loop. Preferably, but not necessarily, the distribution administrator tracks ownership of the digital tokens by all the members of the closed loop. For example, tracking comprises one or more of accounting for a digital token, accounting for a swap of the digital token between members, accounting for a trade between members of the digital token, and tracking ownership of the digital token.

The system further comprises a server, the server operably connected to the distribution administrator. The server is configured to compute an ownership credit earned by a member based on the digital token owned by the member for a unit of time. Preferably, but not necessarily, the server is further configured to compute an ownership credit earned by each member of the closed loop based on each digital token owned by the respective member for the unit of time. The distribution administrator is further configured to send the server an instruction to compute a distribution amount due to a member. Preferably, but not necessarily, the distribution administrator is further configured to send the server an instruction to compute all distribution amounts due to all members of the closed loop. The server is further configured to receive the instruction to compute the distribution amount due to the member. Preferably, but not necessarily, the server is further configured to receive the instruction to compute all distribution amounts due to all members of the closed loop.

The server tracks transaction data regarding one or more of a sale between members of a digital token and a swap between members of a digital token. Using the transaction data, the server generates ownership data. The server also receives ownership data from a member of the closed loop. Preferably, but not necessarily, the server receives ownership data from all members of the closed loop. For example, the server receives the ownership data from an intermediary. For example, the server receives the ownership data from a custodian. The system further comprises a system database operably connected to the server, the system database configured to store ownership data in a retrievable format. The distribution administrator sends the ownership data to the system database. Using the ownership data, the server computes a distribution due to be paid to a member of the closed loop. Preferably, but not necessarily, using the ownership data, the server computes a distribution amount due to be paid to each member of the closed loop. The server sends the computed distribution amount to the distribution administrator. According to embodiments of the invention, the distribution administrator distributes the total distribution down through the closed loop hierarchy to all security holders in the closed loop according to their ownership credits and the value of an ownership credit.

The security holder comprises one or more of an entity and an individual. The security holder holds the shares of the security without having a legal right to the shares. Preferably, but not necessarily, the security holder both holds the securities and receives the total distribution on behalf of the members participating in the closed loop. A distribution by a security comprises one or more of a dividend, interest, capital gain, income, return of capital, shares and another form of income paid to an owner of the security.

For example, the system tracks one or more present ownership of the digital tokens and past ownership of the digital tokens. Preferably, but not necessarily, the system tracks both the present ownership of the digital tokens and the past ownership of the digital tokens. For example, the closed loop is networked. For example, the closed loop comprises an exchange. Preferably, but not necessarily, during the payment period, the member earns ownership credits in proportion to one or more of a time for which the member holds the digital tokens and a number of digital tokens owned at an end of the unit of time. Most preferably, but not necessarily, during the payment period, the member earns ownership credits in proportion to both a time for which the member holds the digital tokens and a number of digital tokens owned at the end of the unit of time. Using a unit of time equal to one day, the equation the server uses to compute the ownership credits a member earns for a payment period is:
(1) Ownership Credits=Σᵢ₌₁ⁿ xᵢ=x₁+x₂+x₃+ . . . +xₙ, where x₁ equals a number of digital tokens a member owned on the first day of a payment period, x₂ equals a number of digital tokens a member owned on the second day, and generally xₙ equals a number of digital tokens owned by the member on the nth day. The nth day is a last day of the payment period for which the member owned digital tokens. The nth day may or may not be the final day of the payment period. This equation represents a cumulative sum of all of the ownership credits earned at the end of each day by a member during a payment period.

The equation the distribution administrator uses to compute the distribution amount the system pays to a member during the payment period is:

$$Distribution Income Payable = ( \frac{TD}{TOC} ) * Ownership Credits , \qquad ( 2 )$$

where TD=equals a total distribution for a security that is held by the security holder, where TOC=a total number of ownership credits that were generated by the digital token in the payment period, and where Ownership Credits represents a number of ownership credits earned in the payment period by the member of the closed loop. For the purpose of this application, a member of the closed loop comprises one or more of an investor and an intermediary appointed by the investor to act on the investor's behalf.

For the purpose of this application, an intermediary comprises an entity appointed by an investor to act on the investor's behalf. The intermediary is operably connected to the investor. The intermediary comprises one or more of a broker, a custodian, a bank, and another type of intermediary. The intermediary is configured to do one or more of hold a digital token on behalf of the investor, hold cash on behalf of the investor, hold another asset on behalf of the investor, consummate a transaction on behalf of the investor, receive a distribution on behalf of the investor, pay a distribution to the investor, and perform recordkeeping on behalf of the investor. For example, the recordkeeping comprises one or more of recordkeeping regarding taxes, recordkeeping regarding security performance, and other recordkeeping. The system can comprise two or more intermediaries. For example, the system comprises both a broker and a custodian as an investor's intermediaries. For example, the intermediary comprises Charles Schwab Corporation of Westlake, Texas (www.schwab.com). For example, the intermediary comprises Yahoo Finance of New York City (http:/finance.yahoo.com).

For example, if the security holder holds 1,000,000 shares of Apple, Inc. for a 90-day payment period, then TOC is equal to (1,000,000)*90=90,000,000. If the member owns 500,000 shares of Apple, Inc. for a 45-day period, then the server computes the member's number of Ownership Credits owned as: Ownership Credits=(500,000)*45=22,500,000. If the total distribution TD equals $45,000,000, then the

$$Distribution Income Payable = ( \frac{TD}{TOC} ) * Ownership Credits = ( \$45 , 000 , 000 / 90 , 000 , 000 ) * 22 , 500 , 000 = \$11 , 250 , 0.$$

The member earns an ownership credit for a unit of time for which they own one digital token. Preferably, but not necessarily, the member earns an ownership credit for each unit of time for which they own the digital token. Most preferably, but not necessarily, each member of the closed loop earns an ownership credit for each unit of time for which the respective member owns digital tokens.

The intermediary is operably connected to the server. The intermediary effectively functions as directed by the investor, interacting as desired by the investor with the distribution administrator. The intermediary is configured to do one or more of hold a digital token on behalf of the investor, hold cash on behalf of the investor, hold another asset on behalf of the investor, consummate a transaction on behalf of the investor, receive a distribution on behalf of the investor, pay a distribution to the investor, and perform recordkeeping on behalf of the investor. In cases where the system comprises two or more intermediaries, preferably, at least one of the intermediaries is operably connected to the investor. Most preferably, but not necessarily, in the cases where the system comprises two or more intermediaries, the intermediaries are each operably connected to the investor. Preferably, but not necessarily, at least one of the intermediaries is operably connected to the server. Most preferably, but not necessarily, the two intermediaries are each operably connected to the server. For example, the system comprises both a broker and a custodian as intermediaries between a member and the distribution administrator.

A digital token provides a member with an ownership credit that represents a legal right to a portion of the income generated by the underlying security that the digital token represents. For example, if a member holds 1 digital token representing one share of Apple, Inc. that the member owns for 45 days of a 90-day payment period, then the member would earn 45 ownership credits. At the end of the payment period, the distribution administrator assigns a value to each ownership credit, based on the total distribution received, and the members will be paid their pro rata income for each ownership credit earned. For example, if the ownership credits are worth $0.02 apiece, then the member will receive a payment of $0.90 or ($0.02*45). Additionally, the system can add a new member of the closed loop. Embodiments of the invention facilitate trading of digital tokens between two or more members of the closed loop.

Members of the closed loop can trade a digital token. Most commonly, but not necessarily, two members of the closed loop trade the digital token. Alternatively, or additionally, the members of the closed loop can swap a digital token. Most commonly, but not necessarily, two members of the closed loop swap the digital token. The members within the closed loop use an exchange to track one or more of a trade and a swap of a digital token at any level within the closed loop. According to embodiments of the invention, the exchange does one or more of execute a trade between members of the closed loop and log a trade made between members of the closed loop. For example, the exchange executes a trade between members of the closed loop. For example, and preferably, but not necessarily, the exchange executes all trades between members of the closed loop. For example, the exchange logs a trade between members of the closed loop. For example, and preferably, but not necessarily, the exchange logs all trades between members of the closed loop. Alternatively, or additionally, according to further embodiments of the invention, the exchange executes and logs all trades made at every level of digital token ownership between members of the closed loop.

The exchange comprises exchange software that facilitates trading digital tokens between the members of the closed loop. Alternatively, or additionally, the exchange comprises exchange software that facilitates a swap of digital tokens between the members of the closed loop. The exchange can be managed by one or more of the distribution administrator and a third party. For example, the closed loop can lease the exchange software. Alternatively, or additionally, the closed loop can manage the exchange. The exchange is configured to track one or more of a digital token transaction between members of the closed loop, a number of digital tokens owned, a number of digital tokens traded, a duration of time for which a digital token is owned, a location of a digital token, an account number of a digital token, and the like. For example, tracking comprises one or more of accounting for a digital token, accounting for a swap of the digital token between members, accounting for a trade between members of the digital token, and tracking ownership of the digital token. The exchange is further configured to do one or more of price, match, track and execute a digital token trade between members of the closed loop. The exchange shares with the distribution administrator transaction data that the exchange generates regarding one or more of buying and selling of the digital tokens. Alternatively, or additionally, the member shares with the distribution administrator transaction data regarding one or more of the member's purchase of the digital token and the member's sale of the digital token.

The server receives ownership data from a member of the closed loop. The ownership data comprises one or more of ownership of a digital token by a member of the closed loop and a location of the digital token owned by the member. Preferably, but not necessarily, the server receives ownership data from all members of the closed loop. Using the ownership data, the server computes a distribution due to be paid to a member of the closed loop. Preferably, but not necessarily, using the ownership data, the server computes all distribution amounts due to be paid to all members of the closed loop. The server sends the computed distribution amount to the distribution administrator. Using the information the distribution administrator receives from the server, the distribution administrator pays the member according to the computed distribution amount due to the member. For example, using the distribution amount computed by the server, the distribution administrator pays the computed distribution from a security to the member by instructing a system financial institution associated with the system to pay the appropriate distribution to a member financial institution designated by the member. For example, the system financial institution comprises one or more of a bank, a credit union, and another financial institution. For example, the member financial institution comprises one or more of a bank, a credit union, and another financial institution.

The member of the closed loop reports to the distribution administrator regarding ownership of a digital token by the member. Preferably, but not necessarily, the member of the closed loop reports to the distribution administrator regarding ownership by the member of all digital tokens owned by the member. Most preferably, but not necessarily, all members of the closed loop report to the distribution administrator regarding the ownership of all digital tokens owned by the respective member. The member of the closed loop further reports to the distribution administrator a location of a digital token owned by the member. Preferably, but not necessarily, the member of the closed loop reports to the distribution administrator regarding respective locations of all digital tokens owned by the member. Most preferably, but not necessarily, all members of the closed loop report to the distribution administrator regarding all locations of all digital tokens owned by the respective member. For example, a member reports to the distribution administrator that a member has earned 150 ownership credits from their IBM digital tokens. For example, the member further reports to the distribution administrator that the member's digital tokens are custodied at a bank known as BNY Mellon Corporation.

The distribution administrator tracks ownership of a security by a member of the closed loop using the corresponding digital token. Preferably, but not necessarily, the distribution administrator tracks ownership of the security by the member of the closed loop using the corresponding digital tokens. Most preferably, but not necessarily, the distribution administrator tracks ownership of the security by all members of the closed loop using the corresponding digital tokens. The distribution administrator creates a unique digital token for each share of a security owned by the security holder. For example, if the security holder holds 1,000,000 shares of stock in Apple, Inc., the distribution administrator creates 1,000,000 unique digital tokens, one digital token representing each share of Apple, Inc. held by the security holder.

Alternatively, or additionally, the distribution administrator requests that the member provide a tax lot regarding a digital token the member owns. A tax lot comprises information showing one or more of a unique identifier showing a type of digital token purchased, a quantity of digital tokens purchased, a purchase price of the digital token, a tax basis for the purchase of the digital token, a day of purchase of the digital token, a time of purchase of the digital token, a day of a sale of the digital token, and a time of a sale of a digital token. Preferably, but not necessarily, the distribution administrator requests that the member provide a tax lot regarding all digital tokens the member owns. Most preferably, but not necessarily, the distribution administrator requests that all members of the closed loop provide tax lots regarding all digital tokens the respective members own. The distribution administrator receives the tax lot from the member. Preferably, but not necessarily, the distribution administrator receives the respective tax lots from all the members.

The distribution administrator is configured to identify a tax lot that a member of the closed loop owns during a payment period. Preferably, but not necessarily, the distribution administrator is configured to identify all tax lot that the member of the closed loop owns during the payment period. Most preferably, but not necessarily, the distribution administrator is configured to identify all tax lots that all members of the closed loop own during the payment period.

The distribution administrator is configured to analyze the tax lot to determine a number of units of time that the tax lot was owned in the payment period and to determine a number of ownership credits earned by the member by multiplying the number of digital tokens of the tax lot by the number of units of time the digital tokens were owned in the payment period. Using the tax lot received from the member, the distribution administrator computes an ownership credit due to the member. Preferably, but not necessarily, using the tax lot received from each of the members of the closed loop, the distribution administrator computes ownership credits due to each of the members of the closed loop.

For example, a tax lot representing 10 digital tokens that were purchased on Jan. 1, 2020 and sold on Feb. 1, 2020 will earn the purchasing member of the closed loop a number of ownership credits equal to a number of days for which the member owns the digital tokens multiplied by a number of digital tokens that the member owns. In this case, Ownership Credits=(31 days owned*10 digital tokens owned)=310 ownership credits.

The distribution administrator is further configured to compute an ownership credit generated by a tax lot received from a member of the closed loop. Preferably, but not necessarily, the system is further configured to compute ownership credits generated by all tax lots received from the member. Preferably but necessarily, the system computes ownership credits generated by all tax lots received from all members of the closed loop.

A digital token comprises a unique identification number. Preferably, but not necessarily, each digital token comprises a unique identification number. The digital token represents a member's legal right to the shares held by the security holder. The member redeems the digital tokens for the physical security by making a redemption request to the distribution administrator.

Digital tokens are designed to trade at prices that represent the fair value of the underlying security held by the security holder and owned by the member. For the purpose of this application, fair value represents the price of the underlying security minus any unpaid distributions. Using the digital token, the distribution administrator determines a security price using one or more of a price of the underlying security and undistributed income of the security during the payment period. Preferably, but not necessarily, using the digital token, the distribution administrator determines the security price using both the price of the underlying security and the undistributed income of the security during the payment period. The distribution administrator computes the security price as equal to a market price of the underlying security minus undistributed income of the security during the payment period. For example, if the price of stock in International Business Machines (IBM) is equal to $140 per share and IBM stock will pay an upcoming dividend distribution of $1.00 per share, the distribution administrator sets a price of the IBM digital token at $139.00 per share.

The distribution administrator sets a price of the digital token so that the digital token can trade in the closed loop at a fixed discount of its market price. The distribution administrator estimates the undistributed income of the security during the payment period. The distribution administrator thus sets the digital token price at a fixed per-share discount. For example, on day 1 of a payment period, if the undistributed income of IBM is $1.00 per share and the market price of IBM on a public exchange is $142.00, then the distribution administrator sets the price to do one or more of buy IBM and sell IBM at a price of ($142.00-$1.00)=$141.00. Alternatively, on day 2, if the price of IBM on a public exchange falls to $138.00, then the price of IBM in the closed loop will be ($138.00-$1.00)=$137.00. As shown below in Table 2, the distribution administrator can set a fixed discount that does not change throughout the payment period. This is an example of the system fully discounting an upcoming distribution. Alternatively, or additionally, as shown below in Table 3, the distribution administrator sets a gradual discount that increases in equal proportions over the course of the payment period.

Alternatively, or additionally, the price of the digital token is not fixed.

The distribution administrator tracks ownership within the closed loop of a digital token during a given payment period. Preferably, but not necessarily, the distribution administrator tracks all ownership of all digital tokens by all members of the closed loop during the given payment period. Alternatively, or additionally, a member directs that an intermediary track the ownership of the digital token within the closed loop during the payment period. According to these embodiments, the intermediary notifies the distribution administrator regarding the ownership tracking results on a periodic basis requested by the distribution administrator. For example, if the unit of time used to determine earned ownership credits is one day, then the intermediary sends to the distribution administrator a daily accounting of a digital token owned by a member. Preferably, but not necessarily, the intermediary sends to the distribution administrator a daily accounting of all digital tokens owned by the member. Most preferably, but not necessarily, each intermediary sends to the distribution administrator respective daily accountings of all digital tokens owned by all members.

When the payment period ends, in proportion to ownership credits that have accrued during the payment period and are therefore earned by the member, the distribution administrator pays a distribution to the member. Via one or more intermediaries, the distribution administrator ultimately pays the distribution to the investor. For example, in cases where the investor appoints an intermediary, the intermediary operably connected to the server, the distribution administrator operably connected to the security holder, the intermediary further operably connected to an investor, the distribution passed from the security holder to the distribution administrator, and then to the intermediary, and then the distribution passes from the intermediary to the investor. For example, in cases in which the investor appoints two intermediaries, a first intermediary operably connected to the security holder, and a second intermediary operably connected to the first intermediary, the second intermediary further operably connected to the investor, the distribution administrator pays the distribution to the first intermediary, who then pays the distribution to the second intermediary. The second intermediary then pays the distribution to the investor.

To compute the distribution due to the member, the distribution administrator, using distribution software, divides (a gross distribution, which is a total amount of income received by the security holder for the security during the payment period) by (a total number of ownership credits received by all members for the digital tokens during the payment period), giving a distribution value per ownership credit. Then the server computes a distribution due the member by multiplying the distribution value per ownership credit by a number of ownership credits owned by the member during the payment period. Preferably, but not necessarily, the server computes distributions due all members. Alternatively, or additionally, as mentioned above, for a member who instead directs that the intermediary track the member's security ownership within the closed loop, the intermediary computes the member distribution due the member by multiplying a number of ownership credits earned by the member by the value of an ownership credit as computed by the distribution administrator. The intermediary can perform this step directly or using distribution software that the distribution administrator provides to the intermediary.

The distribution administrator can collect and pay distributions directly to the members individually. Alternatively, or additionally, the distribution administrator can pay an investor distribution on behalf of an investor to the investor's designated intermediary. Then, using the distribution software provided by the distribution administrator, the intermediary pays the investor distributions to the individual investors. For example a distribution can be paid to several members of the closed loop. For example, for an investor that designates as intermediaries both a custodian and a broker, the distribution administrator pays a distribution to a custodian, for further payment to a broker who uses the custodian for custody, for further payment to the individual investors via the broker's individual accounts.

The system includes a plurality of components such as one or more of electronic components, hardware components, and computer software components. A number of such components can be combined or divided in the system. An example component of the system includes a set and/or series of computer instructions written in or implemented with any of a number of programming languages, as will be appreciated by those skilled in the art.

The system in one example employs one or more computer-readable signal-bearing media. The computer-readable signal bearing media store software, firmware and/or assembly language for performing one or more portions of one or more implementations of the invention. The computer-readable signal-bearing medium for the system in one example comprises one or more of a magnetic, electrical, optical, biological, and atomic data storage medium. For example, the computer-readable signal-bearing medium comprises one or more of floppy disks, magnetic tapes, CD-ROMs, DVD-ROMs, hard disk drives, downloadable files, files executable “in the cloud,” electronic memory, and another computer-readable signal-bearing medium.

Embodiments of the invention employ a payment system to determine the allocation of income distributions from securities. For example, the payment system makes payments from a security issuer to a holder of the security based on the member's ownership of the digital tokens created for each security held by the security holder in the closed loop during the payment period. For example, the payment system makes payments from the security issuer to a subset of all holders of the security. For example, the subset comprises all members of the closed loop.

Any logic or application described herein that comprises software or code can be embodied in any non-transitory computer-readable medium for use by or in connection with an instruction execution system in a computer system or other system. In this sense, the logic may comprise, for example, statements including instructions and declarations that can be fetched from the computer-readable medium and can be executed by the instruction execution system. In the context of the present disclosure, a computer-readable medium can be any medium that can contain, store, or maintain the logic or application described herein for use by or in connection with the instruction execution system. For example, the computer-readable medium may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

Members of the closed loop are connected via a network configured to operably connect components of the system including the server and the clopsed loop. Preferably, but not necessarily, all members of the closed loop are connected via a network. For the purpose of this application, the network facilitates sharing information between the members of the closed loop. For example, the network shares information about the digital tokens owned by a member with one or more of the distribution administrator and with another member. The system shares the information to consummate a transaction between members. For example, for a given transaction, the system shares the information to confirm one or more of that a buyer of a digital token has cash available to make a digital token purchase and that a seller of the digital token possesses digital tokens the buyer wishes to purchase.

According to embodiments of the invention, the distribution administrator tracks digital token ownership at multiple levels within the closed loop. Preferably, but not necessarily, the distribution administrator simultaneously tracks digital token ownership at multiple levels within the closed loop. According to further embodiments of the invention, the distribution administrator tracks digital token ownership between multiple members within the closed loop. For example, instead of the distribution administrator tracking digital token ownership at an individual account level, an intermediary can track the ownership of digital tokens owned by their individual members. The intermediary reports to the distribution administrator regarding digital token ownership by the members. Preferably, but not necessarily, the intermediary reports to the distribution administrator regarding digital token ownership by all the members. In this scenario, the distribution administrator will not possess ownership information of the individual accounts. The distribution administrator pays a distribution based on the intermediary's total ownership of the digital tokens. The intermediary uses distribution software provided by the distribution administrator to compute payments that are due to members.

For example, an intermediary can be a broker and/or a custodian. For example, the brokerage firm comprises individual client accounts. For example, a custodian can have multiple brokerage firms, at least one brokerage firm maintaining custody at the custodian of digital tokens of at least one of the clients of the brokerage firm. Preferably, but not necessarily, each brokerage firm maintains custody at the custodian of digital tokens of each of the clients of the brokerage firm.

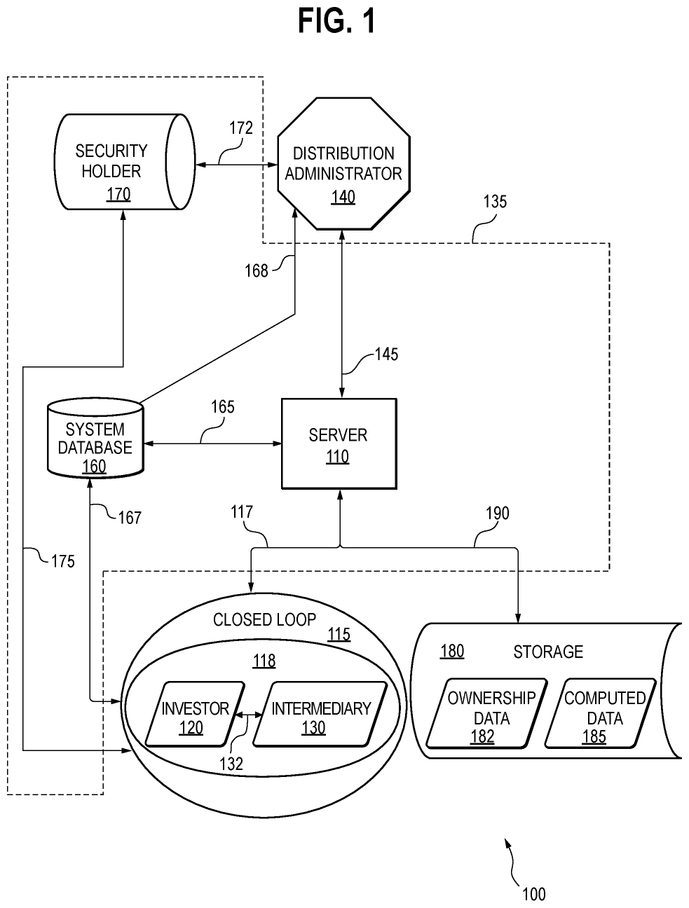

FIG. 1 illustrates an exemplary payment system 100 for improving security pricing using digital tokens in a closed loop.

FIG. 1 illustrates a system 100 that can be constructed and operated using physical onsite components. Alternatively, or additionally, the system 100 illustrated in FIG. 1 could also be constructed and operated using a cloud-based system architecture. Preferably, but not necessarily, FIG. 1 depicts the system 100 suitable for use with physical onsite components. For example, in the case of a cloud-based system architecture, the cloud-based system comprises a system sold by Amazon Web Services (AWS), a subsidiary of Amazon.com of Seattle, Washington (www.amazon.com).

The system 100 comprises a server 110, the server 110 configured to do one or more of process ownership data and control the system 100. The server 110 comprises computer code usable to process the ownership data. The server 110 is configured to compute the ownership data.

The system 100 further comprises a closed loop 115, the closed loop 115 operably connected to the server 110. The server 110 tracks transaction data generated by the exchange regarding one or more of a sale between members 118 of a digital token and a swap between members 118 of a digital token. Using the transaction data, the server 110 generates ownership data. The server processes ownership data regarding ownership of a security by the member 118. The server 110 also receives ownership data from a member 118 of the closed loop 115. Preferably, but not necessarily, the server 110 receives ownership data from all members 118 of the closed loop 115. For example, the server 110 receives the ownership data from an intermediary 130. For example, the server 110 receives the ownership data from a custodian. The server 110 stores the ownership data in the system database 160. The member 118 takes custody of the digital tokens pertaining to the member's securities.

For example, and as depicted, the closed loop 115 is operably connected to the server 110 through a wired server-loop network connection 117.

The closed loop 115 comprises a member 118. The member 118 comprises an investor 120.

Optionally, the member 118 further comprises an intermediary 130, the intermediary 130 comprising an entity appointed by the investor 120 to act on behalf of the investor 120. The intermediary 130 is operably connected to the investor 120 by an investor-intermediary network connection 132. Alternatively, or additionally, the intermediary 130 is operably connected to the investor 120 via an account the investor 120 has with the intermediary 130. The intermediary 130 comprises one or more of a broker, a custodian, a bank, and another type of intermediary. The intermediary 130 is configured to do one or more of hold a digital token on behalf of the investor 120, hold cash on behalf of the investor 120, hold another asset on behalf of the investor 120, consummate a transaction on behalf of the investor 120, receive a distribution on behalf of the investor 120, pay a distribution to the investor 120, and perform another administrative task on behalf of the investor 120.

As depicted, the system 100 further comprises a network 135, the network configured to connect components of the system 100 including the server 110 and the closed loop 115. The network 135 comprises one or more of a wired network, a wireless network, and another network. Preferably, but not necessarily, the network 135 comprises a wired network. The network 135 comprises the wired server-loop network connection 117 and the investor-intermediary network connection 132.

For example, the server-loop network connection 117 can comprise an Internet connection, while the rest of the network 135 comprises a wired network.

For example, the server 110 communicates with the closed loop 115 via one or more of a network connection using the network 135, the cloud, a wired connection, and another connection. The network 135 comprises the server-loop network connection 117 operably connecting the server 110 and the closed loop 115. As depicted, the server 110 communicates with the closed loop 115 via the server-loop network connection 117.

The system 100 further comprises a distribution administrator 140 operably connected to the server 110. The distribution administrator 140 is configured to receive from the member 118 ownership data regarding ownership of a security. The distribution administrator 140 is further configured to transmit the ownership data to the server 110. The distribution administrator 140 is configured to create a digital token to track ownership of a security by a member 118 within the closed loop 115 during a payment period, thereby generating updated ownership data. The updated ownership data comprises one or more of updated ownership of a digital token by a member of the closed loop and an updated location of the digital token owned by the member. The distribution administrator 140 is further configured to send the updated ownership data to the server 110. The server 110 is further configured to receive the updated ownership data from the distribution administrator 140.

The distribution administrator 140 credits the digital token to an account of the member 118 who contributes the security associated with the digital token. The distribution administrator 140 tracks ownership within the closed loop 115 by a member 118 of a digital token during a given payment period. Preferably, but not necessarily, the distribution administrator 140 tracks all ownership within the closed loop 115 for all members 118 of the digital tokens during the given payment period. The distribution administrator 140 is further configured to accept a new member 118 into the closed loop 115. The server 110 is configured to receive from the distribution administrator 140 the ownership data. The server 110 is further configured to compute a distribution amount to be paid to a member 118 of the closed loop 115. The distribution administrator 140 provides the server 110 with distribution software usable by the server 110 to compute a distribution amount due to a member 118 of the closed loop 115. Preferably, but not necessarily, the distribution administrator 140 provides the server 110 with distribution software usable by the server 110 to compute all distribution amounts due to all member 118 of the closed loop 115. The distribution administrator 140, using the server-administrator network connection 145, sends the server 110 an instruction to compute a distribution amount due to a member 118 of the closed loop 115. Preferably, but not necessarily, the distribution administrator 140 sends the server 110 an instruction to compute all distribution amounts due to the member 118 of the closed loop 115. Most preferably, but not necessarily, the distribution administrator 140 sends to the server 110 an instruction to compute all distribution amounts due to all members 118 of the closed loop 115.

Using the updated ownership data, the server 110 computes a distribution amount due to a member 118 of the closed loop 115. Preferably, but not necessarily, using the updated ownership data, the server 110 computes all distribution amounts due to the member 118 of the closed loop 115. Most preferably, but not necessarily, using the updated ownership data, the server 110 computes all distribution amounts due to all members 118 of the closed loop 115.

For example, the distribution administrator 140 comprises a login module (not shown) suitable for use by the distribution administrator 140 to log into the server 110. The system 100 further comprises a user interface (not shown) suitable for use by the distribution administrator 140 to interface with the server 110 following a successful login to the server 110. Via a server-administrator network connection 145, which connects the server 110 to the distribution administrator 140, the distribution administrator 140 communicates with the server 110.

The distribution administrator 140 is further configured, using the server-administrator network connection 145, to send the ownership data to the system database 160. The distribution administrator 140 is further configured, using the server-administrator network connection 145, to send the updated ownership data to the system database 160. The server 110 also uses the server-administrator network connection 145 to send the computed distribution amount to the distribution administrator 140. Using the computed distribution amount, the distribution administrator 140 pays the computed distribution from a security to the member 118 at the end of the payment period. In the event the member 118 comprises a second intermediary 130, using the computed distribution amount, the intermediary 130 then pays the computed distribution to a second intermediary 130, and so on, and ultimately the final intermediary 130 pays the investor 120.

For example, the distribution administrator 140 pays the distribution to the member 118 by instructing a system financial institution associated with the system 100 to pay the appropriate distribution to a member financial institution designated by the member 118. For example, the system financial institution comprises one or more of a bank, a credit union, and another financial institution. For example, the member financial institution comprises one or more of a bank, a credit union, and another financial institution. A digital token provides a member 118 with an ownership credit that represents a legal right to a portion of the income generated by the underlying security that the digital token represents.

The system 100 further comprises a system database 160 operably connected to the server 110 via a server-database network connection 165. The system database 160 is further operably connected to the closed loop 115 via a loop-database network connection 167. The system database 160 is further operably connected to the distribution administrator 140 via an administrator-database network connection 168.

The system database 160 comprises one or more of a physical system database and a cloud-based system database. The system database 160 is configured to do one or more of receive ownership data from the server 110, store ownership data usable by the server 110, import ownership data from the closed loop 115, store the ownership data, receive a request from the server 110 for needed ownership data, export the ownership data to the server 110 via the server-database network connection 165, export the ownership data to the closed loop 115 via the loop-database network connection 167, and export the ownership data to the distribution administrator via the administrator-database network connection 168. Preferably, but not necessarily, the system database 160 is configured to receive the ownership data from the server 110, store the ownership data usable by the server 110, import the ownership data from the closed loop 115, store the ownership data, receive a request from the server 110 for needed ownership data, and export the needed ownership data to one or more of the server 110, the closed loop 115, and the distribution administrator 140.

The system 100 further comprises a security holder 170 configured to hold the security, the security holder 170 operably connected to the distribution administrator 140 via an administrator-holder network connection 172, the security holder 170 operably connected to the closed loop 115 via a loop-holder network connection 175. The security holder 170 is further configured to receive a total distribution on behalf of a member 118 of the closed loop 115. For example, the security holder 170 receives the total distribution from a security issuer. For example, the security issuer comprises one or more of a corporation and a registered investment company. For example, the corporation comprises Apple, Inc. of Cupertino, California (www.apple.com).

The security holder 170 is further configured to send to the distribution administrator 140, over the administrator-holder network connection 172, a total distribution of a security on behalf of a member 118 of the closed loop 115. The total distribution comprises a distribution due to the member 118 of the closed loop 115 for a security owned by the member 118 within the closed loop 115 during the current payment period. Preferably, but not necessarily, the total distribution comprises all distributions due to all members 118 of the closed loop 115 for securities owned by the members 118 within the closed loop 115 during the current payment period. The security holder 170 then sends the total distribution to the distribution administrator 140.

The system 100 further comprises storage 180 configured to store ownership data 182. The storage is further configured to store computed data 185, the computed data 185 comprising a computation by the server 110 of a distribution amount due to a member 118 of the closed loop 115. Preferably, but not necessarily, the computed data 185 comprises computations by the server 110 of distributions due to all members 118 of the closed loop 115. After computing the distribution due to the member 118 of the closed loop 115, the server 110 then sends the computed distribution amount due to the member 118 to storage 180 to be saved as computed data 185. Preferably, but not necessarily, after computing the distributions due to all the members 118 of the closed loop 115, the server 110 then sends to the storage 180 the computed distribution amounts due to all the members 118 of the closed loop 115 to be saved as computed data 185. Preferably, but not necessarily, the distribution administrator 140 sends the ownership data 182 to the storage 180 to be saved. Alternatively, or additionally, the distribution administrator 140 sends the ownership data 182 to the system database 160 to be saved.

The network 135 comprises one or more of the server-loop network connection 117 operably connecting the server 110 and the closed loop 115, the server-administrator network connection 145 operably connecting the server 110 and the distribution administrator 140, the server-database network connection 165 operably connecting the server 110 the loop-database network connection 167 operably connecting the closed loop 115 and the system database 160, the database-administrator network connection 168 operably connecting the distribution administrator 140 and the system database 160, an administrator-holder network connection 172 operably connecting the distribution administrator 140 and the security holder 170, a loop-holder network connection 175 operably connecting the closed loop 115 and the security holder 170, and a server-storage network connection 190 operably connecting the server 110 and the storage 180.

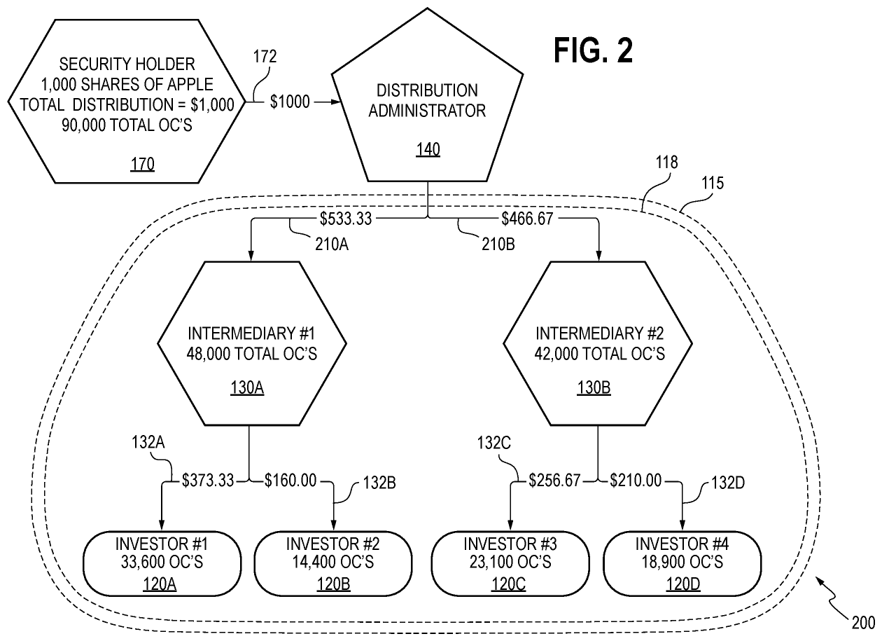

FIG. 2 depicts a hierarchical representation of a payment system 200 for improving security pricing using digital tokens in a closed loop 115 with one security holder 170, one distribution administrator 140 operably connected to the security holder 170 by the administrator-holder network connection 172, and with transactions occurring at multiple levels of the closed loop 115. The closed loop 115 comprises members 118 of the closed loop 115. The members 118 comprise one or more of investors 120 and intermediaries 130. As depicted, the members 118 of the closed loop 115 of the payment system 200 comprise a first intermediary 130A, a second intermediary 130B, a first investor 120A, a second investor 120B, a third investor 120C, and a fourth investor 120D. Each of the intermediaries 130A-130B comprises one or more of a broker and a custodian.

The first intermediary 130A is operably connected to the distribution administrator 140 by a first-intermediary-administrator network connection 210A. The second intermediary 130B is also operably connected to the distribution administrator 140 by a second-intermediary-administrator network connection 210B. The first-intermediary-administrator network connection 210A comprises an operable combination of the server-loop network connection (item 117 in FIG. 1; not shown in FIG. 2) and the server-administrator network connection (item 145 in FIG. 1; not shown in FIG. 2) from FIG. 1. Similarly, the second-intermediary-administrator network connection 210B comprises an operable combination of the server-loop network connection (item 117 in FIG. 1; not shown in FIG. 2) and the server-administrator network connection (item 145 in FIG. 1; not shown in FIG. 2) from FIG. 1. The first intermediary 130A is operably connected to the first investor 120A by a first-investor-intermediary network connection 132A, the first investor 120A appointing the first intermediary 130A. The first intermediary 130A is also operably connected to the second investor 120B by a second-investor-intermediary network connection 132B, the second investor 120B also appointing the first intermediary 130A. The second intermediary 130B is operably connected to the third investor 120C by a third-investor-intermediary network connection 132C, the third investor 120C appointing the second intermediary 130B. The second intermediary 130B is also operably connected to the fourth investor 120D by a fourth-investor-intermediary network connection 132D, the fourth investor 120D also appointing the second intermediary 130B.

It should be noted that FIG. 2 is not a literal representation of the system 200 but rather a symbolic representation of how the system 200 operates to make distributions over a representative quarter of 90 days from a security holder 170 to a distribution administrator 140, then in appropriate portions to the two intermediaries 130A-130B, the two intermediaries 130A-130B appointed by the four respective investors, and finally in appropriate portions to the four investors 120A-120D. The two intermediaries 130A-130B and the four investors 120A-120D are all necessarily members of the closed loop 115.

The security holder 170 holds 1,000 shares of Apple, Inc. stock for a 90-day payment period. The distribution administrator 140 creates 1,000 Apple, Inc. digital tokens that the members 118 of the closed loop 115 own.

First, the distribution administrator 140 determines a total number of ownership credits generated by the 1,000 shares held at the security holder 170. Using a time unit of one day to determine when ownership credits are generated, the system sums the ownership credits generated for each day of the payment period. For this example, the shares of Apple, Inc. held by the security holder 170 were fixed for the entire 90-day payment period. The distribution administrator 140 determines that 90,000 Apple, Inc. ownership credits were generated for the payment period. The distribution administrator 140 computes that 1,000 ownership credits were earned each day for 90 days, creating 90,000 total ownership credits.

Next, the distribution administrator 140 determines the value of each ownership credit by dividing the total distribution received by the Apple, Inc. shares by the total number of ownership credits generated. The total distribution received by the Apple, Inc. shares is $1,000 and the total ownership credits generated is 90,000. Therefore the value of one ownership credit is equal to ($1,000/90,000)=$0.011111111.

Once the distribution administrator 140 establishes the value of an ownership credit, the distribution administrator 140 can pay the $1,000 total distribution to the members 118 of the closed loop 115 based on the number of ownership credits that the distribution administrator 140 computes were earned by the members 118 of the closed loop 115. The total number of ownership credits earned by the members 118 of the closed loop 115 is equal to the total number of ownership credits that the distribution administrator 140 computes, in this example, 90,000 ownership credits. The $1,000 total distribution is transferred from the security holder 170 to the distribution administrator 140 for the purpose of paying the members of the closed loop 115.

First, the distribution administrator 140 determines payments to each intermediary 130A-130B by multiplying the number of ownership credits an intermediary 130A-130B earned by the value of an ownership credit. The distribution administrator 140 computes that the distribution administrator 140 pays the first intermediary 130A a sum equal to (Ownership Credits Earned*Value of an Ownership Credit)=(48,000*0.011111111)=$533.33. The distribution administrator 140 computes that the distribution administrator 140 pays the second intermediary 130B a sum equal to (Ownership Credits Earned*Value of an Ownership Credit)=(42,000*$0.011111111)=$466.67. The distribution administrator 140 pays a total amount of money to both intermediaries 130A-130B that is equal to the total distribution of $1,000. Using the computed distribution amounts, the distribution administrator 140 pays the computed distributions from a security to one or more of the two intermediaries 130A-130B by instructing a system financial institution associated with the respective intermediary 130A-130B to pay the appropriate distributions to an intermediary financial institution designated by the respective intermediary 130A-130B. For example, the system financial institution comprises one or more of a bank, a credit union, and another financial institution. For example, the respective intermediary financial institution comprises one or more of a bank, a credit union, and another financial institution.

Next, the intermediaries 130A-130B pay appropriate respective distributions to their respective investors 120A-120B and 120C-120D, the respective investors 120A-120B and 120C-120D, holding their digital tokens at the respective intermediaries 130A-130B. The first intermediary 130A pays the first investor 120A a sum of money equal to (Ownership Credits Earned*Value of an Ownership Credit)=(33,600*$0.011111111)=$373.33. The first intermediary 130A pays the second investor 120B a sum of money equal to (Ownership Credits Earned*Value of an Ownership Credit)=(14,400*$0.011111111)=$160.00.

The second intermediary 130B pays the third investor 120C a sum of money equal to (Ownership Credits Earned*Value of an Ownership Credit)=(23,100*$0.011111111)=$256.67. The second intermediary 130B pays the fourth investor 120D a sum of money equal to (Ownership Credits Earned*Value of an Ownership Credit)=(18,900*$0.011111111)=$210.00.

The respective intermediaries 130A-130B compute their respective payments to the respective investors 120A-120B and 120C-120D. Alternatively, or additionally, the server 110 computes a payment to be made by the first intermediary 130A to the first investor 120A using the first-investor-intermediary network connection 132A. Alternatively, or additionally, the server 110 computes a payment to be made by the first intermediary 130A to the second investor 120B using the second-investor-intermediary network connection 132B. In the embodiments in which the server 110 makes the computations, the server 110 sends the computed payment to the first intermediary 130A, using the first-intermediary-administrator network connection 210A with instructions regarding the payments that the first intermediary 130A needs to make to the investors 120A and 120B. Using the computed distribution amounts, the first intermediary 130A pays the computed distributions from a security to one or more of the two investors 120A-120B by instructing the intermediary financial institution associated with the first intermediary 130A to pay the appropriate distribution to a member financial institution designated by the respective investor 120A-120B. For example, the intermediary financial institution comprises one or more of a bank, a credit union, and another financial institution. For example, the respective member financial institution comprises one or more of a bank, a credit union, and another financial institution.

Alternatively, or additionally, the server 110 computes a payment to be made by the second intermediary 130B to the third investor 120C using the second-investor-intermediary network connection 132C. Alternatively, or additionally, the server 110 computes a payment to be made by the second intermediary 130B to the fourth investor 120D using the fourth-investor-intermediary network connection 132D. In the embodiments in which the server 110 makes the computations, the server 110 sends the computed payment to the second intermediary 130B, using the second-intermediary-administrator network connection 210B with instructions regarding the payments that the second intermediary 130B needs to make to investors 120C and 120D. Using the computed distribution amounts, the second intermediary 130B pays the computed distributions from a security to one or more of the two investors 120C-120D by instructing the intermediary financial institution associated with the second intermediary 130B to pay the appropriate distribution to a member financial institution designated by the respective investor 120C-120D. For example, the intermediary financial institution comprises one or more of a bank, a credit union, and another financial institution. For example, the respective member financial institution comprises one or more of a bank, a credit union, and another financial institution.

Once the investors 120A-120D have received all the payments, the total money the investors 120A-120D have received should equal the total distribution or ($373.33+$160.00+$256.67+$210.00)=$1,000.00.

Table 1 tabulates these computations in a concise format:

TABLE 1

| | |
|---|---|
| $ 1,000.00 | <Total Distribution |
| 90,000 | <Total Ownership Credits Generated for |
| | Payment Period |
| $0.011111111 | <Value per ownership credit |

| | | |
|---|---|---|
| Credits | Payment | Recipient |

Payments to Intermediary #1

| | | |
|---|---|---|
| 48,000 | $ 533.33 | Intermediary 1 |
| 33,600 | $ 373.33 | Investor 1 |
| 14,400 | $ 160.00 | Investor 2 |

Payments to Intermediary #2

| | | |
|---|---|---|
| 42,000 | $ 466.67 | Intermediary 2 |
| 23,100 | $ 256.67 | Investor 3 |
| 18,900 | $ 210.00 | Investor 4 |

| | |
|---|---|
| $ 1,000.00 | Total distributed to investors |
| $ 1,000.00 | Total distributed to intermediaries |

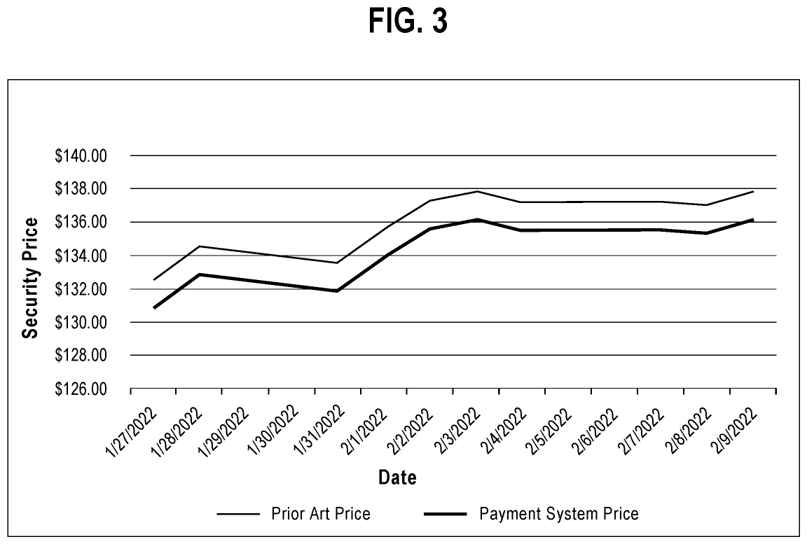

FIG. 3 is a graph of pricing of a security, for example, of International Business Machines (IBM), according to the prior art system and according to embodiments of the invention. The difference in pricing relates to the fact that, in contrast to the prior art last holder of record system, the method and system allow members to fully discount an upcoming dividend payment from the price of the security. The difference in these two IBM prices is related to the discounting by market participants of 100% of the upcoming dividend payment over the course of the payment period. During this period of time, the difference in pricing between the underlying IBM security and the system price is equal to $1.64 which is equivalent to the total IBM upcoming dividend distribution. This example shows a market that fully discounts an upcoming dividend distribution.

Table 2 shows the difference in pricing between a price of the underlying IBM security traded on a public exchange and a price of IBM traded in the payment system and method for improving security pricing using digital tokens over a payment period, assuming fixed pricing:

TABLE 2

| Date | Underlying Price | System Price | Difference |
|---|---|---|---|
| Nov. 8, 2021 | $ 118.96 | $ 117.32 | $ 1.64 |
| Nov. 15, 2021 | $ 116.05 | $ 114.41 | $ 1.64 |
| Nov. 22, 2021 | $ 115.81 | $ 114.17 | $ 1.64 |
| Nov. 29, 2021 | $ 118.84 | $ 117.20 | $ 1.64 |
| Dec. 6, 2021 | $ 124.09 | $ 122.45 | $ 1.64 |
| Dec. 13, 2021 | $ 127.40 | $ 125.76 | $ 1.64 |
| Dec. 20, 2021 | $ 130.63 | $ 128.99 | $ 1.64 |
| Dec. 27, 2021 | $ 133.66 | $ 132.02 | $ 1.64 |
| Jan. 3, 2022 | $ 134.83 | $ 133.19 | $ 1.64 |
| Jan. 10, 2022 | $ 134.21 | $ 132.57 | $ 1.64 |
| Jan. 17, 2022 | $ 129.35 | $ 127.71 | $ 1.64 |
| Jan. 24, 2022 | $ 134.50 | $ 132.86 | $ 1.64 |
| Jan. 31, 2022 | $ 137.15 | $ 135.51 | $ 1.64 |
| Feb. 7, 2022 | $ 137.79 | $ 136.15 | $ 1.64 |

Table 3 shows the difference in pricing between the underlying IBM security and the IBM digital token in the closed loop. In this example, the $1.64 dividend is gradually discounted over the course of the payment period.

TABLE 3

| Date | Underlying Price | System Price | Difference |
|---|---|---|---|
| Nov. 8, 2021 | $ 118.96 | $ 118.84 | $ 0.12 |
| Nov. 15, 2021 | $ 116.05 | $ 115.82 | $ 0.23 |
| Nov. 22, 2021 | $ 115.81 | $ 115.46 | $ 0.35 |
| Nov. 29, 2021 | $ 118.84 | $ 118.37 | $ 0.47 |
| Dec. 6, 2021 | $ 124.09 | $ 123.50 | $ 0.59 |
| Dec. 13, 2021 | $ 127.40 | $ 126.70 | $ 0.70 |
| Dec. 20, 2021 | $ 130.63 | $ 129.81 | $ 0.82 |
| Dec. 27, 2021 | $ 133.66 | $ 132.72 | $ 0.94 |
| Jan. 3, 2022 | $ 134.83 | $ 133.78 | $ 1.05 |
| Jan. 10, 2022 | $ 134.21 | $ 133.04 | $ 1.17 |
| Jan. 17, 2022 | $ 129.35 | $ 128.06 | $ 1.29 |
| Jan. 24, 2022 | $ 134.50 | $ 133.09 | $ 1.41 |
| Jan. 31, 2022 | $ 137.15 | $ 135.63 | $ 1.52 |
| Feb. 7, 2022 | $ 137.79 | $ 136.15 | $ 1.64 |

There are multiple ways to discount an upcoming distribution from the price on an income producing security. Table 2 shows how the payment system and method for improving security pricing using digital tokens in a closed loop can fully discount an upcoming distribution and Table 3 shows how the payment system and method for improving security pricing using digital tokens in a closed loop can gradually discount an upcoming dividend over the course of a payment period.

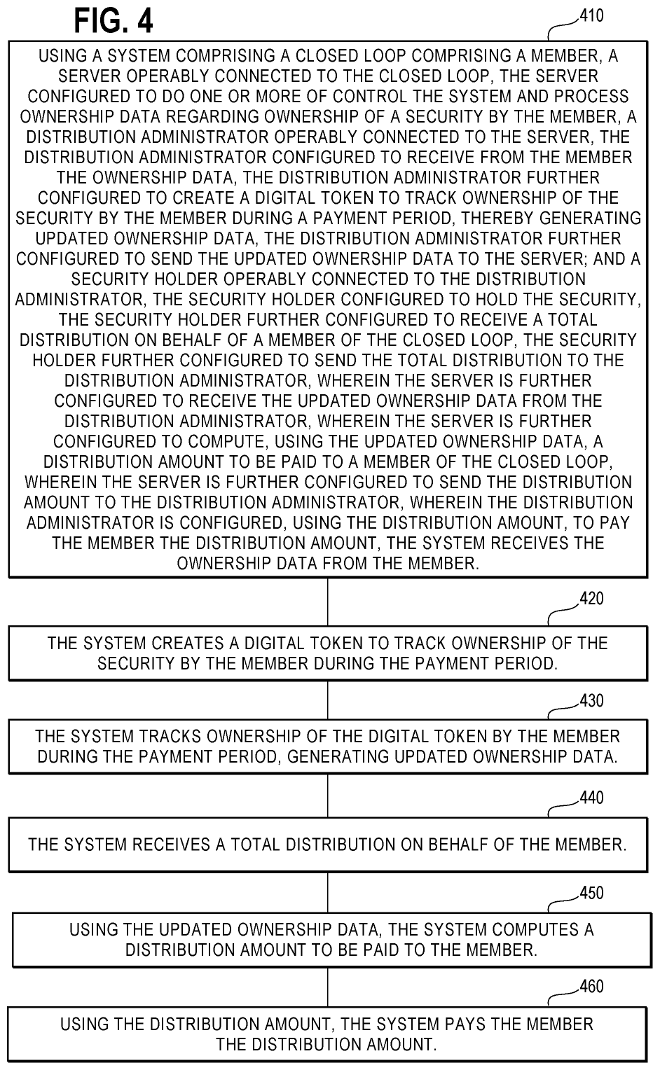

FIG. 4 is a flow chart of a method 400 for improving security pricing using digital tokens in a closed loop.

The order of the steps in the method 400 is not constrained to that shown in FIG. 4 or described in the following discussion. Several of the steps could occur in a different order without affecting the final result.

In step 410, using a system comprising a closed loop comprising a member, a server operably connected to the closed loop, the server configured to do one or more of control the system and process ownership data regarding ownership of a security by the member, a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder operably connected to the distribution administrator, the security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, the system receives the ownership data from the member. Block 410 then transfers control to block 420.

In step 420, the system creates a digital token to track ownership of the security by the member during the payment period. For example, the creating step further comprises creating digital tokens to track ownership of the security owned by the members during the payment period. Block 420 then transfers control to block 430.

In step 430, the system tracks ownership of the digital token by the member during the payment period, generating updated ownership data. Block 430 then transfers control to block 440.

In step 440, the system receives a total distribution on behalf of the member. Block 440 then transfers control to block 450.

In step 450, using the updated ownership data, the system computes a distribution amount to be paid to the member. For example, the computing step further comprises computing, using the updated ownership data, all distribution amounts due to all members of the closed loop. For example, the computing step further comprises computing the distribution amount to be paid to the member using an equation:

$$Distribution Amount = ( \frac{TD}{TOC} ) * Ownership Credits , \qquad ( 2 )$$

where TD=equals a total distribution for a security that is held by the security holder, where TOC=a total number of ownership credits that were generated by the digital token in the payment period, and where Ownership Credits represents a number of ownership credits earned in the payment period by the member of the closed loop.

The method optionally further comprises an additional step, performed after the computing step, of sending the computed distribution amount to the member. For example, the sending step further comprises sending the computed distribution amounts to all the members. The method optionally further comprises an additional step, performed prior to the computing step, of calculating an ownership credit earned by a member based on the digital token owned by the member for a unit of time. For example, the calculating step further comprises calculating an ownership credit earned by each member of the closed loop based on each digital token owned by the respective member for the unit of time. Block 450 then transfers control to block 460.

In step 460, using the distribution amount, the system pays the member the distribution amount. Block 460 then terminates the process.

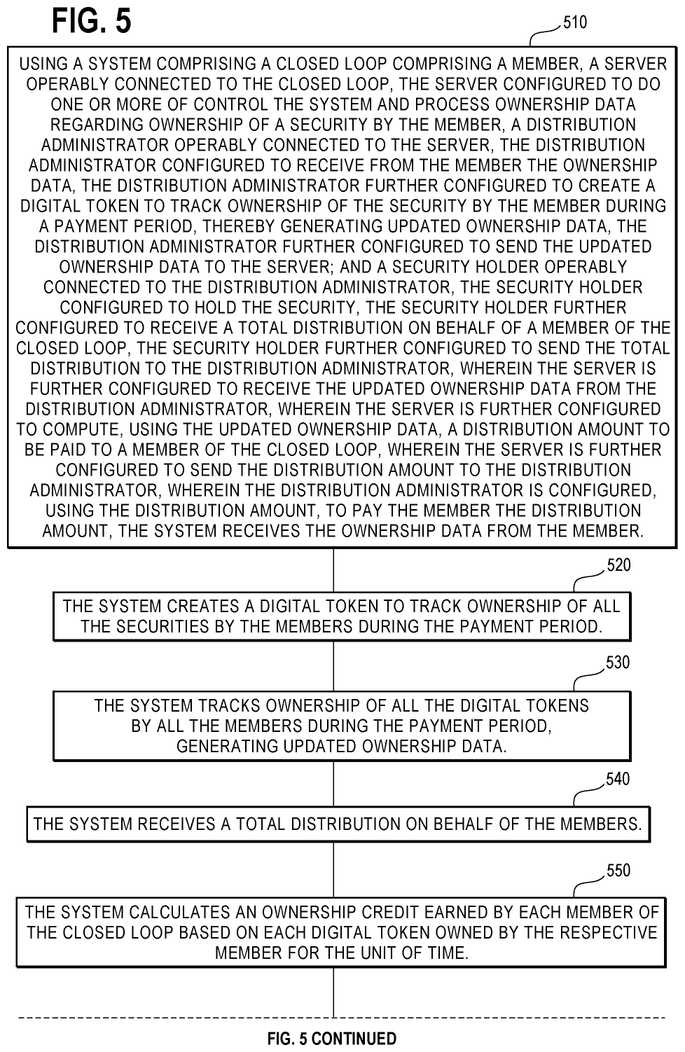

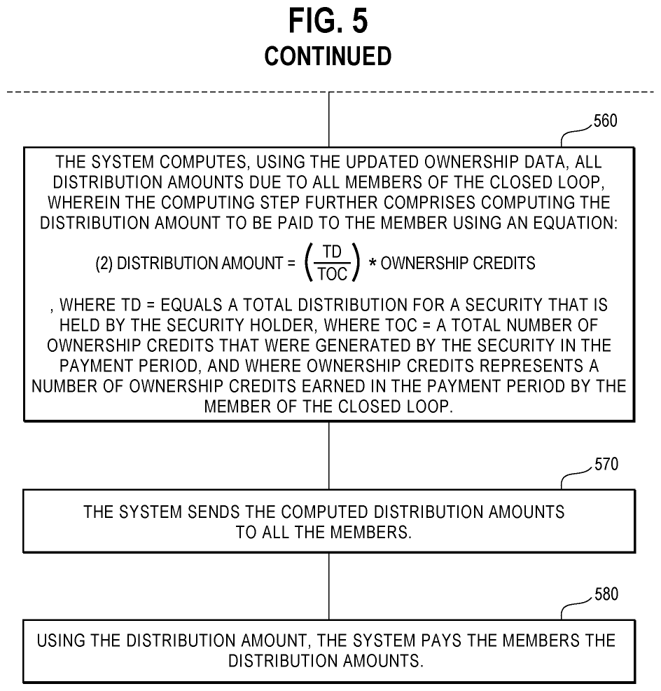

FIG. 5 is a flow chart of a method for improving security pricing using digital tokens in a closed loop.

The order of the steps in the method 500 is not constrained to that shown in FIG. 5 or described in the following discussion. Several of the steps could occur in a different order without affecting the final result.

In step 510, using a system comprising a closed loop comprising a member, a server operably connected to the closed loop, the server configured to do one or more of control the system and process ownership data regarding ownership of a security by the member, a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder operably connected to the distribution administrator, the security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, the system receives the ownership data from the member. Block 510 then transfers control to block 520.

In step 520, the system creates a digital token to track ownership of all the securities by the members during the payment period. Block 520 then transfers control to block 530.

In step 530, the system tracks ownership of all the digital token by all the member during the payment period, generating updated ownership data. Block 530 then transfers control to block 540.

In step 540, the system receives a total distribution on behalf of the members. Block 540 then transfers control to block 550.

In step 550, the system calculates an ownership credit earned by each member of the closed loop based on each digital token owned by the respective member for the unit of time. Block 550 then transfers control to block 560.

In step 560, the system computes, using the updated ownership data, all distribution amounts due to all members of the closed loop, wherein the computing step further comprises computing the distribution amount to be paid to the member using an equation:

$$Distribution Amount = ( \frac{TD}{TOC} ) * Ownership Credits , \qquad ( 2 )$$

where TD=equals a total distribution for a security that is held by the security holder, where TOC=a total number of ownership credits that were generated by the digital token in the payment period, and where Ownership Credits represents a number of ownership credits earned in the payment period by the member of the closed loop. Block 560 then transfers control to block 570.

In step 570, the system sends the computed distribution amounts to all the members. Block 570 then transfers control to block 580.

In step 580, using the distribution amount, the system pays the members the distribution amounts. Block 580 then terminates the process.

According to embodiments of the invention, the distribution administrator tracks a position in digital tokens owned by a member of the closed loop. Preferably, but not necessarily, the distribution administrator tracks a real-time position in digital tokens owned by a member of the closed loop. Most preferably, but not necessarily, the distribution administrator tracks real-time positions in digital tokens owned by each member of the closed loop. The distribution administrator is configured to receive from a member a real-time position in the digital tokens owned by the member of the closed loop. Preferably, but not necessarily, the distribution administrator is configured to receive from all members of the closed loop real-time positions in the digital tokens owned by the members of the closed loop. For example, the distribution administrator receives from an investor that is a member of the closed loop a notification that at the end of a day, the investor holds 1,500 digital tokens of Apple, Inc. According to further embodiments of the invention, the distribution administrator knows a total number of digital tokens owned by all the members of the closed loop. Alternatively, or additionally, the distribution administrator knows a number of digital tokens owned by a member of the closed loop at a given time on a given day. Alternatively, or additionally, the distribution administrator knows a number of digital tokens owned by all members of the closed loop at a given time on a given day.

According to other embodiments of the invention, optionally, prior to execution of a transaction, one or more of ownership of digital tokens by a particular member and an ability of a member to fund a proposed transaction can be verified.

According to embodiments of the invention, the exchange can share a record of transactions made within the system with the distribution administrator. For example, the distribution administrator analyzes a transaction. Preferably, but not necessarily, the distribution administrator analyzes each of the transactions. For example, the distribution administrator computes a payment of income from a security to all of the security owners based upon the value of an ownership credit and the number of ownership credits earned by each member in the closed loop holding digital tokens representing a certain underlying security.

Alternatively, or additionally, the distribution administrator tracks the number of digital tokens owned by certain members within the closed loop. For example, the distribution administrator performs a distribution computation at multiple levels of the closed loop in order to carry out a distribution to each security holder within the closed loop. For example, the distribution administrator can pay an intermediary based on the number of ownership credits earned by the members of the intermediary. The intermediary can then further distribute the distribution to each member of the intermediary based on the number of ownership credits they earned. These payments will continue until all of the distribution has been distributed to each member of the closed loop.

The distribution administrator can comprise a custodian that physically handles digital tokens on behalf of members. Alternatively, or additionally, the distribution administrator can comprise a separate entity that instructs one or more of the intermediary and other members of the closed loop regarding distribution payment to the members of the income generated by the securities held by the security holder.

According to further embodiments of the invention, the distribution administrator tracks ownership of digital tokens on one or more of a pooled basis and a fixed basis.

When ownership is tracked on a pooled basis, the number of securities, for a certain security held by the security holder can change during the payment period. For example, for a three-month payment period the total number of securities held by the security holder for IBM can be 1000 for month one, 1050 for month 2 and 1025 for month 3. In this example, the total ownership credits for all 3 months are tallied. Then, the total distribution is divided by the total number of ownership credits earned by all members for the period. This division produces the value of one ownership credit. Lastly, the value of one ownership credit is multiplied by the total number of ownership credits earned by each member or intermediary to generate the total distribution payable to each member of the closed loop. For example, the total ownership credits generated in month 1 is 30,000, in month 2 is 31,500 and for month 3 is 30,750. This example assumes that each month has 30 days and that ownership credits are issued daily. The 1025 securities owned at the end of month 3 will receive a $1.00 per share distribution or a total distribution of $1025.00. The gross distribution of $1,025 is divided by the total distribution credits for all members of 92,250 or $0.011111 per ownership credit. If a member earns 9,225 ownership credits for the payment period their distribution is computed as follows: (9,225*0.011111)=$102.50.

Ownership can also be tracked on a fixed basis. When ownership is tracked on a fixed basis, the number of securities held at the security holder, for a certain security, does not change during a payment period. The number of securities held for a certain security by the security holder can increase or decrease, but only at the beginning of a new payment period. The computation to determine the value of each ownership credit and the distribution of income to members based on their earned ownership credits does not change from the example above.

Embodiments of the invention allow a member to obtain an estimate of the income they have earned at any time in the payment period. The distribution administrator can make an estimate of the value of each ownership credit. This estimate of the value of an ownership credit can be used to estimate the income on a member who owns a certain number of credits by multiplying the value of the credits by the number of credits they earned.

Each digital token can have a unique digital ledger.

Each digital token can have a digital ledger comprising an ownership history of the digital token. For example, the digital ledger comprises an ownership history of the digital token for each time interval. For example, the digital ledger comprises an ownership history of the digital token for each payment period. For example, the digital ledger tracks when the digital token was bought by and investor and when it was sold by the investor.

For example, each digital token will have a unique security identifier. The unique identifier will identify which underlying security is associated with the digital token as well as numbers that are unique to each digital token. Using units of time, the digital ledger system tracks a duration of ownership, based on standardized units of time, for a member who owns a digital token, during a given payment period. Preferably, but not necessarily, the digital ledger system tracks the duration of ownership, based on standardized units of time, for each investor who owns a digital token during the given payment period. At the end of the payment period, the digital ledger system analyzes the number of earned ownership credits for which a member owned the digital token.

Digital token ownership and payments can be tracked using a decentralized ledger system which can account for the ownership of all digital tokens, the ownership credits earned and the distribution payments made to investors.

The Appendix contains pseudocode for the method for equitably allocating a financial distribution.

Advantages provided by embodiments of the invention are one or more of more equitable security pricing and more accurate security pricing.

An additional advantage of embodiments of the invention is allowing buyers of fixed income securities to avoid paying the seller accrued interest earned by the fixed income security at the time of the purchase. Another advantage is that since the systems and methods allow a seller to be paid their earned interest when the interest is paid, buyers do not need to pay sellers accrued interest at the time of the purchase. A still further advantage is that not having to pay a seller accrued interest at the time of a purchase allows the buyer to purchase more bonds and earn a higher return.

A yet other advantage of embodiments of the invention is allowing a buyer of fixed income to avoid paying the seller at a time of the sale the accrued interest earned by the fixed income instrument. A still further advantage of embodiments of the invention is that the seller of the digital token receives their accrued interest distribution when the fixed income instrument pays its distribution to the security holder.

An additional advantage provided by embodiments of the invention is overcoming limitations of the prior art system requiring bond purchasers to pay a bond's “dirty price,” that is, the bond's par value plus a premium equal to interest that has accrued for the bond since the previous coupon payment. A further advantage provided by embodiments of the invention is avoiding a requirement of the prior art system that, in addition to the bond's fair market price, accrued interest be paid to the seller at the time of purchase. A yet additional advantage provided by embodiments of the invention is avoiding the attendant lowering of a member's return on their capital due to the investor's failure to earn a return on the accrued interest paid.

Other advantages provided by embodiments of the invention include enabling a purchaser to purchase more bonds as a result of favorable security pricing and enabling the seller to receive a pro rata share of accrued income.

A still other advantage of embodiments of the invention is avoiding overvaluation by the prior art system of securities by requiring buyers of the security to pay an inequitably elevated price for the security equal to its fair market value plus any unpaid distribution.

Another advantage of embodiments of the invention is providing a method and system for paying out a total distribution to all holders within the payment system of the securities for a given payment period. A yet further advantage of embodiments of the invention is providing a method and system for paying out a distribution based on a number of digital tokens owned by investors and a number of ownership credits earned. This advantage guarantees that all investors earn income, including investors who owned but sold their digital tokens prior to the payment of the distribution by the underlying securities. The prior art only pays the last holders of record. Sellers receive no income.

A still other advantage of embodiments of the invention is improving security pricing within the payment system.

Another advantage of embodiments of the invention is providing a system and method for paying out a total distribution that avoids disadvantages of the prior art system whereby a security's payable income is incorrectly characterized as an asset of the security, when, in fact, a security's payable income is a liability of the security. A still other advantage of embodiments of the invention is eliminating the flawed prior art accounting of journaling a large payable liability on the ex-dividend day, thereby decreasing the value of the asset and causing the security's price to fall on the ex-dividend day. A further advantage of embodiments of the invention is allowing a security issuer to accrue income payable to shareholders on a frequent basis, thus avoiding journaling a large liability payable on the ex-dividend day.

A yet further advantage of embodiments of the invention is eliminating the prior art practice of forcing investors to buy a company's undistributed income because the undistributed income is treated as an asset and becomes a component of the value of the security. A yet additional advantage is thereby enabling investors to avoid being taxed on the return of their capital, often at ordinary income rates. For example, a member may be compelled to pay a tax that is levied on the purchased undistributed income that is returned to the investor as taxable income. Such a tax is completely avoided by the method and system provided according to embodiments of the invention. Another advantage provided by embodiments of the invention is eliminating the prior art requirement that investors accordingly overpay for an income-producing equity security they buy, causing investors to purchase fewer shares and earn a lower investment return.

An additional advantage of embodiments of the invention is providing a method and system that allows members of the closed loop who own securities to anticipate an upcoming distribution. A still further advantage of embodiments of the invention is providing a method and system that allowed members of the closed loop to avoid an associated drop in the security's value on a known date. Yet other advantages of embodiments of the invention are that members are thereby enabled to begin discounting upcoming dividend payment from the price of the security.

A further advantage of the embodiments of the invention is that investors who are able to purchase securities for their fair value and who are able to avoid adverse tax consequences of purchasing a security's undistributed income will enjoy higher before and after-tax investment returns.

Embodiments of the invention offer an advantage of allowing pre-verification of the ownership and amount of securities to be sold and further verification that the seller actually owns the securities. Additionally, embodiments of the invention offer a further advantage of allowing for pre-verification of the buyer's available funds. The ability offered by embodiments of the invention for the investor to verify one or more of that the sellers actually own the securities, and that the buyer has the funds needed to make a purchase allows investors to transact directly without needing a securities clearing and settlement process. This reduces transaction costs for investors and allows securities to settle instantaneously.

Another advantage of embodiments of the invention is improving security pricing for investors by creating security prices that more accurately reflect the value of the security. An additional advantage of embodiments of the invention is increasing investor returns. Another advantage of embodiments of the invention is enhancing investor buying power.

A further advantage of embodiments of the invention is they allow an efficient market properly to discount a security price based on an upcoming distribution. An additional advantage of embodiments of the invention is that they overcome limitations of the prior art last owner of record system that prevented the market from accurately discounting an anticipated distribution over the course of a payment period.

Another advantage of embodiments of the invention is that it allows all holders of a security to be paid income from the securities they owned, even those investors who sold the securities prior to the ex-dividend or coupon payment date.

A further advantage of embodiments of the invention is that investors will pay lower management fees on the digital tokens they hold because of the fair pricing of the digital tokens.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

What is claimed is:

1. A payment system for improving security pricing using digital tokens in a closed loop, comprising:
a closed loop comprising a member;
a server operably connected to the closed loop, the server configured to do one or more of control the system and process ownership data regarding ownership of a security by the member;
a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and
a security holder operably connected to the distribution administrator, the security holder configured to hold the security, the security holder further configured to receive a total distribution on behalf of a member of the closed loop, the security holder further configured to send the total distribution to the distribution administrator,
wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount.

2. The system of claim 1, wherein the digital token comprises an electronic data unit configured to provide the member of the closed loop with an ownership credit that represents a legal right to income generated by the underlying security that the digital token represents.

3. The system of claim 2, wherein the digital token represents one share of the security owned by the member during the payment period of the security.

4. The system of claim 1, wherein the member comprises one or more of an investor and an intermediary appointed by the investor to act on the investor's behalf.

5. The system of claim 4, wherein the member comprises an intermediary.

6. The system of claim 5, wherein the intermediary ultimately pays the payment to the investor.

7. The system of claim 6, wherein the intermediary is operably connected to the investor.

8. The system of claim 5, wherein the intermediary is operably connected to the distribution administrator.

9. The system of claim 5, wherein the intermediary comprises one or more of a broker, a custodian, and a bank.

10. The system of claim 5, wherein the intermediary is configured to do one or more of hold the digital token on behalf of the investor, hold cash on behalf of the investor, hold another asset on behalf of the investor, consummate a transaction on behalf of the investor, receive a distribution on behalf of the investor, pay a distribution to the investor, and perform an administrative task on behalf of the investor.

11. The system of claim 1, wherein the server computes all distribution amounts due to all members of the closed loop.

12. The system of claim 1, wherein the server sends the computed distribution amount to the distribution administrator.

13. The system of claim 1, wherein the server sends the computed distribution amount to the distribution member.

14. The system of claim 1, further comprising storage configured to store one or more of ownership data and a computed distribution amount.

15. The system of claim 14, wherein the server sends the computed distribution amount to storage.

16. The system of claim 1, further comprising a system database operably connected to the server, the system database configured to store ownership data in a retrievable format, wherein the distribution administrator sends the updated ownership data to the system database.

17. The system of claim 14, wherein the distribution administrator sends the updated ownership data to storage.

18. The system of claim 1, wherein the distribution administrator is further configured to create digital tokens to track ownership of all the securities owned by the members during the payment period.

19. The system of claim 1, wherein the distribution administrator is further configured to track a real-time position in digital tokens owned by the member.

20. The system of claim 18, wherein the distribution administrator tracks real-time positions in digital tokens owned by each member of the closed loop.

21. The system of claim 2, wherein the server is further configured to compute the ownership credit earned by a member based on the digital token owned by the member for a unit of time.

22. The system of claim 21, wherein the server computes an ownership credit earned by each member of the closed loop based on each digital token owned by the respective member for the unit of time.

23. The system of claim 1, wherein the distribution administrator is further configured to accept a new member into the closed loop.

24. The system of claim 1, wherein the distribution administrator sends the server an instruction to compute a distribution amount due to a member.

25. The system of claim 24, wherein the distribution administrator sends the server an instruction to compute all distribution amounts due to all members of the closed loop.

26. The system of claim 1, wherein the distribution administrator computes the distribution amount to be paid to the member using an equation:
$$Distribution Amount = ( \frac{TD}{TOC} ) * Ownership Credits , \qquad ( 2 )$$
where TD=equals a total distribution for a security that is held by the security holder, where TOC=a total number of ownership credits that were generated by the digital token in the payment period, and where Ownership Credits represents a number of ownership credits earned in the payment period by the member of the closed loop.

27. The system of claim 1, further comprising a network configured to operably connect components of the system including the server and the closed loop.

28. The system of claim 1, wherein the ownership data comprises one or more of ownership of a digital token by a member of the closed loop and a location of the digital token owned by the member.

29. The system of claim 1, wherein the updated ownership data comprises one or more of updated ownership of a digital token by a member of the closed loop and an updated location of the digital token owned by the member.

30. A method for improving security pricing using digital tokens in a closed loop, comprising:
using a system comprising a closed loop comprising a member, a server operably connected to the closed loop, the server configured to do one or more of control the system and process ownership data regarding ownership of a security by the member, a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder operably connected to the distribution administrator, the security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, receiving, from the member, the ownership data;
creating a digital token to track ownership of the security by the member during the payment period;
tracking ownership of the security by the member during the payment period, generating updated ownership data;
receiving a total distribution on behalf of the member;
computing, using the updated ownership data, a distribution amount to be paid to the member; and
using the distribution amount, paying the member the distribution amount.

31. The method of claim 30, wherein the digital token comprises an electronic data unit configured to provide a member of the closed loop with an ownership credit that represents a legal right to income generated by the underlying security that the digital token represents.

32. The method of claim 31, wherein the digital token represents one share of the security owned by a member during a payment period of the security.

33. The method of claim 30, wherein the computing step further comprises computing, using the updated ownership data, all distribution amounts due to all members of the closed loop.

34. The method of claim 33, further comprising an additional step, performed after the computing step, of sending the computed distribution amount to the member.

35. The method of claim 34, wherein the sending step further comprises sending the computed distribution amounts to all the members.

36. The method of claim 30, wherein the creating step further comprises creating digital tokens to track ownership of all the securities owned by the members during the payment period.

37. The method of claim 31, wherein the method further comprises an additional step, performed prior to the computing step, of calculating an ownership credit earned by a member based on the digital token owned by the member for a unit of time.

38. The method of claim 37, wherein the calculating step further comprises calculating an ownership credit earned by each member of the closed loop based on each digital token owned by the respective member for the unit of time.

39. The method of claim 30, wherein the computing step further comprises computing the distribution amount to be paid to the member using an equation:
$$Distribution Amount = ( \frac{TD}{TOC} ) * Ownership Credits , \qquad ( 2 )$$
where TD=equals a total distribution for a security that is held by the security holder, where TOC=a total number of ownership credits that were generated by the digital token in the payment period, and where Ownership Credits represents a number of ownership credits earned in the payment period by the member of the closed loop.

40. The method of claim 30, wherein the ownership data comprises one or more of ownership of a digital token by a member of the closed loop and a location of the digital token owned by the member.

41. The method of claim 30, wherein the updated ownership data comprises one or more of updated ownership of a digital token by a member of the closed loop and an updated location of the digital token owned by the member.

42. A method for improving security pricing using digital tokens in a closed loop, comprising:
using a system comprising a closed loop comprising a member, a server operably connected to the closed loop, the server configured to do one or more of control the system and process ownership data regarding ownership of a security by the member, a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server; and a security holder operably connected to the distribution administrator, the security holder configured to hold the security, the security holder further configured to receive a total distribution on behalf of a member of the closed loop, the security holder further configured to send the total distribution to the distribution administrator, wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, receiving, from the member, the ownership data;
creating a digital token to track ownership of the security by the members during the payment period;
tracking ownership of the security by the members during the payment period, generating updated ownership data;
receiving a total distribution on behalf of the members;
calculating an ownership credit earned by each member of the closed loop based on each digital token owned by the respective member for the unit of time;
computing, using the updated ownership data, all distribution amounts due to all members of the closed loop, wherein the computing step further comprises computing the distribution amount to be paid to the member using an equation:
$$Distribution Amount = ( \frac{TD}{TOC} ) * Ownership Credits , \qquad ( 2 )$$
where TD=equals a total distribution for a security that is held by the security holder, where TOC=a total number of ownership credits that were generated by the digital token in the payment period, and where Ownership Credits represents a number of ownership credits earned in the payment period by the member of the closed loop;
sending the computed distribution amounts to all the members; and
using the distribution amount, paying the members the distribution amounts.

43. A payment system for improving security pricing using digital tokens in a closed loop, comprising:
a closed loop comprising a member;
a server operably connected to the closed loop, the server configured to do one or more of control the system and process ownership data regarding ownership of a security by the member, wherein the server computes all distribution amounts due to all members of the closed loop, wherein the server sends the computed distribution amount to the member;
a distribution administrator operably connected to the server, the distribution administrator configured to receive from the member the ownership data, the distribution administrator further configured to create a digital token to track ownership of the security by the member during a payment period, thereby generating updated ownership data, the distribution administrator further configured to send the updated ownership data to the server, wherein the server sends the computed distribution amount to the distribution administrator, wherein the distribution administrator sends the updated ownership data to the system database;
a security holder operably connected to the distribution administrator, the security holder configured to hold the security, the security holder further configured to receive a total distribution on behalf of a member of the closed loop, the security holder further configured to send the total distribution to the distribution administrator; and
storage operably connected to the server, the storage configured to store one or more of ownership data and a computed distribution amount, wherein the server sends the computed distribution amount to the storage,
wherein the server is further configured to receive the updated ownership data from the distribution administrator, wherein the server is further configured to compute, using the updated ownership data, a distribution amount to be paid to a member of the closed loop, wherein the server is further configured to send the distribution amount to the distribution administrator, wherein the distribution administrator is configured, using the distribution amount, to pay the member the distribution amount, wherein the digital token comprises an electronic data unit configured to provide a member of the closed loop with an ownership credit that represents a legal right to income generated by the underlying security that the digital token represents, wherein the digital token represents one share of the security owned by a member during a payment period of the security, wherein the member comprises one or more of an investor and an intermediary appointed by the investor to act on the investor's behalf, wherein the intermediary ultimately pays the payment to the investor, wherein the intermediary is operably connected to the investor, wherein the intermediary is operably connected to the distribution administrator, wherein the intermediary comprises one or more of a broker, a custodian, and a bank, wherein the intermediary is configured to do one or more of hold the digital token on behalf of the investor, hold cash on behalf of the investor, hold another asset on behalf of the investor, consummate a transaction on behalf of the investor, receive a distribution on behalf of the investor, pay a distribution to the investor, and perform an administrative task on behalf of the investor, wherein the distribution administrator computes the distribution amount to be paid to the member using an equation:
$$Distribution Amount = ( \frac{TD}{TOC} ) * Ownership Credits , \qquad ( 2 )$$
where TD=equals a total distribution for a security that is held by the security holder, where TOC=a total number of ownership credits that were generated by the digital token in the payment period, and where Ownership Credits represents a number of ownership credits earned in the payment period by the member of the closed loop.
